(19) United States
(12) Patent Application Publication
(10) Pub. No.: US 2008/0114684 A1
(43) Pub. Date: May 15, 2008

(54) TERMINATION OF TRANSACTIONS

(76) Inventor: Chuck Foster, Yountville, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/554,854

(22) Filed: Oct. 31, 2006

(51) Int. Cl. H04L 9/00

(52) U.S. Cl. 705/51

(57) ABSTRACT

A system and method of terminating a transaction between a merchant and customer are disclosed.

### BACKGROUND

1. Field

The subject matter disclosed herein related to transactions between a seller and a customer.

2. Information

Technological advances in financial services have enabled efficient non-cash transactions between merchants and customers. The evolution of credit cards and debit cards have enabled efficient payment for goods and/or services without the use of cash. In such non-cash transactions, a merchant typically receives information regarding a credit and/or debit card, which is then used to process payment with a financial institution that issues the credit and/or debit card. Additionally, the use of the Internet to process transactions between merchants and customers increasingly involves transmitting a customer's sensitive financial information over public networks. Accordingly, there is a desire to provide customers with additional protection from the risks of transmitting sensitive financial information over a public network such as the Internet.

### BRIEF DESCRIPTION OF THE FIGURES

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of a financial transaction system according to an embodiment;

FIG. 2 is a flow diagram illustrating a process for handling non-cash transactions between a merchant and a customer according to an embodiment;

FIG. 3 is a schematic diagram of a financial transaction system for paying merchant invoices according to an embodiment;

FIG. 4 is a flow diagram illustrating a process for paying merchant invoices according to an embodiment;

FIG. 5 is a schematic diagram of a financial transaction system for making off-line purchases according to an embodiment;

FIG. 6 is a flow diagram of a process to handle off-line purchases according to an embodiment;

FIG. 7 is a flow diagram of a process to determine whether a transaction should be allowed to complete or terminated according to an embodiment;

FIG. 8 is a schematic diagram of a computing platform according to an embodiment;

FIG. 9 is a schematic diagram of components within a computing platform according to an embodiment;

FIGS. 10A through 10D are diagrams illustrating information that may be transmitted between parties in a non-cash transaction according to an embodiment;

FIG. 11 is a purchase log of transactions according to an embodiment; and

FIG. 12 is a schematic diagram of an electronic shopping cart viewable in a graphical user interface (GUI) to enable a customer to specify purchase of goods and/or services from a merchant according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “terminating,” “downloading,” “identifying,” “initiating,” “querying,”, “obtaining,” “hosting,” “maintaining,” “representing,” “modifying,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium. Further, unless specifically stated otherwise, process described herein, with reference to flow diagrams or otherwise, may also be executed and/or controlled, in whole or in part, by such a computing platform.

A “seller” as referred to herein relates to a party and/or entity that engages in transactions to provide goods and/or services in exchange for payment. In one embodiment, a seller may comprise a “merchant” that regularly engages in providing particular goods and/or services in exchange for payment as an on-going enterprise. Alternatively, a seller may comprise a private party which is willing to provide a good and/or service on a limited basis (e.g., a private party). However, these are merely examples of a seller and claimed subject matter is not limited in this respect.

A “customer” as referred to herein relates to a party and/or entity that engages in transactions with a seller to receive such goods and/or services in exchange for payment. For example, a seller may provide goods and/or services to one or more customers in exchange for payment from such customers in the form of cash payment, credit, account debit, barter exchange and/or the like. However, this is merely an example of how a seller and customer may engage in transactions for providing goods and/or services in exchange for payment, and claimed subject matter is not limited in these respects.

According to an embodiment, a seller may provide goods and/or services to a customer for non-cash payment. In particular examples, although claimed subject matter is not limited in these respects, such non-cash payment may be financed through credit that the customer has established with a merchant or a financial intermediary using, for example, a credit card. “Credit” refers to an amount of payment a merchant and/or is willing to receive from a customer as a non-cash payment, or an amount of a non-cash transaction a financial intermediary is willing to finance on behalf of such a customer. Such credit may quantify an allowable account balance which the customer promises to pay at a future date. Alternatively, such credit may comprise a cash balance that the customer has established a merchant and/or a financial intermediary using, for example, a debit card. However, these are merely examples of how a seller and customer may engage in a non-cash transaction for providing goods and/or services, and claimed subject matter is not limited in these respects. Also, it should be understood that actions performed by a customer, merchant and/or financial intermediary may be carried out, in whole or in part, by a computing platform.

Embodiments described herein relate to, among other things, systems and method of processing financial transactions. As illustrated in U.S. Pat. No. 6,332,134 titled “Financial Transaction System,” one or more intermediaries may be involved in the processing of a non-cash transaction between a merchant and a customer in such a manner that the merchant does not need access to the customer's sensitive financial information and/or other personal information to complete the transaction. Here, a customer and a merchant may agree on terms of a proposed non-cash transaction to purchase a good and/or service to be financed through, for example, a credit card or debit card transaction. The customer may then forward information regarding the transaction to a financial intermediary (e.g., a credit financial intermediary). The financial intermediary may then forward a payment notification to the merchant to enable completion of the non-cash transaction. The merchant may then provide the goods and/or services, and the financial intermediary and the customer may settle accounts following the purchase.

While the aforementioned system enables completion of non-cash transactions without revealing a customer's sensitive information to a seller, a customer may benefit from additional protection from sellers. According to a particular embodiment, although claimed subject matter is not limited in this respect, a transaction between a customer and a seller may be terminated based, at least in part, on “metadata” which is descriptive and/or indicative of a particular seller involved in the transaction. As illustrated below, such metadata may be collected and/or maintained by a service that is contracted to collect and/or provide such metadata to be used in determining whether a transaction between a customer and seller should be completed or terminated.

According to an embodiment, although claimed subject matter is not limited in these respects, “completion” or “termination” of a financial transaction may occur upon any one of several events associated with such completion or termination of a financial transaction. In one embodiment, completion may occur upon tendering a good and/or service to a customer, payment of funds to a merchant or a confirmation (or promise) to a merchant that payment for a good and/or service is forthcoming. However, these are merely examples of events that may be used to define a completion of a transaction and claimed subject matter is not limited in these respects. In one embodiment, termination of a transaction may occur upon an event and/or condition that prevents completion of a transaction. For example, such a termination of a transaction may occur upon an event and/or condition that prevents payment to a merchant, notice of payment and/or delivery of goods and/or services. However, this is merely an example of a termination of a transaction and claimed subject matter is not limited in this respect.

According to particular embodiments described herein, financial transactions may be completed by transmitting information over data networks using any one of several communication protocols such as, for example, the Internet protocol and related communication protocols. For convenience, references to the Internet are used herein, but embodiments are equally applicable to any type of data network. According to particular embodiments, a transaction between a customer and merchant may be completed without transmission of a customer's sensitive information, such as credit card information and/or other personal financial information, over the Internet. Accordingly, such sensitive information need not leave the possession of the customer to complete the transaction. Also, embodiments described herein may be suitable for use in any country and with any currency, since embodiments of the system allow financial institutions to effectuate currency exchange based on any existing exchange rates.

According to an embodiment, participants in a financial transaction system may comprise a seller, customer, and/or one or more financial intermediaries. While the following discussion illustrates interactions among such a seller, customer and a financial intermediary as a merchant, customer and financial intermediary, respectively, these are merely examples provided for illustration of a particular embodiment of a financial transaction system. Other financial transaction systems may facilitate interactions involving a customer that is not a card holder, or a financial intermediary that is not a financial intermediary and/or a seller that is not a merchant, and claimed subject matter is not limited in this respect.

In transaction illustrated below, a merchant may comprise any party capable of providing a good and/or service to a customer as part of a credit and/or non-cash transaction. In one particular embodiment, although claimed subject matter is not limited in this respect, a merchant may provide and/or dispense cash to a customer in a transaction that is financed by a financial intermediary. For example, such a merchant may operate an automatic teller machine (ATM). Here, the good and/or service being purchased by a customer is cash. However, this is merely an example embodiment and claimed subject matter is not limited in this respect.

According to an embodiment, a financial intermediary, such as a credit card company, may provide credit to a customer, such as a credit card holder. For example, the financial intermediary may comprise a credit card company, a bank, a credit union, or other financial institution capable of facilitating credit card transactions. Such credit provided to a customer can be derived from any type of account, such as a credit card account, debit card account, a bank account, savings account, checking account or brokerage account. However, these are merely examples of how credit may be provided to a customer using particular types of accounts and claimed subject matter is not limited in these respects. Therefore, virtually any type of financial institution and/or financial intermediary can provide credit to the customer based on any type of account without deviating from claimed subject matter.

In one embodiment, individuals comprising members of a family may be authorized as customers to make purchase on behalf of the family based upon their status in the family. Here, for example, a parent may be given unlimited authority while children may have limited purchasing authority to purchase only certain goods or make purchase only from specific merchants. However, these are merely examples of how a family purchasing policy may limit purchasing authority of children and claimed subject matter is not limited in this respect.

A customer may establish an account with a financial intermediary to obtain credit which may be use to make financial transactions including, for example, purchase of goods and/or services, or payment of invoices. Such an account established by a customer may be associated with confidential personal information such as, for example, an account number and credit limit. A financial transaction system may eliminate any need for the transmission of such confidential information outside the control of the customer. A merchant may participate in a financial transaction system by providing information about items to be purchased and by agreeing to be paid by a financial intermediary on behalf of a customer.

According to an embodiment, and as illustrated below with specific examples, a customer merchant and/or financial intermediary may be associated with a communication devices and/or computing platforms capable of communicating with one another over a data communication network. In a particular example, although claimed subject matter is not limited in this respect, a customer may participate in non-cash transactions with a merchant by using a personal computer, cell phone, personal digital assistant, two-way pager and/or interactive television that receives user inputs from a remote control. However, these are merely examples devices that may enable a customer to participate in a non-cash transaction according to a particular embodiment and claimed subject matter is not limited in this respect.

According to an embodiment, a customer may register with a financial transaction system by contacting a financial intermediary and requesting that one or more of the customer's accounts be available for use in the financial transaction system. During such customer registration, a customer may receive software to install on the customer's computing platform. Such software may contain, for example, code and/or information that can be recognized by a registered merchant's website that allows a purchase using the financial transaction system. Such software may contain a changeable user password, a customer ID, a “Sales Log” database, dialing software, instructions, off-line catalog sites, and any miscellaneous promotions and/or data. A customer may load such software on his or her computing platform and follow step by step instructions culminating in clicking on a “Register Now” button on a graphical user interface (GUI), for example. Executing the software, the computing platform may then contact the financial intermediary by, for example, dialing the financial intermediary's toll free number (e.g., using the computing platform's phone modem) or through other on-line means (e.g., Internet protocol over a broadband modem). Following such contact of the financial intermediary, a registration process may be conducted. Here, according to a particular embodiment, a customer's ID and password may be checked against the financial intermediary's records. At registration, a different password may be chosen. For example, in one particular embodiment, multiple customer IDs and passwords can be assigned to the same card and/or account number.

An Order Verification Reply Target (OVRT) may be provided by the customer comprising information enabling a financial intermediary to address messages to the customer comprising order confirmations or other information. Such an OVRT may comprise, for example, a telephone number to receive voice and/or facsimile communications, an e-mail address, Universal Resource Locator (URL), domain name and/or the like to which real-time communications may be addressed. It should be understood, however, that these are merely examples of information that may be used for addressing messages to a customer regarding a transaction and claimed subject matter is not limited in these respects. It may also be possible for the customer to register by voice over the telephone, fax or mail, however, installing computer software on customer's computing platform allows the customer to use the financial transaction system when making purchases over data networks, like the Internet.

A merchant may register with the financial intermediary to use a financial transaction system to become authorized to accept payment for providing goods and/or services in transactions with customers using a financial transaction system as described herein. For example, the financial intermediary and merchant may agree to use an Automatic Clearing House (ACH) to allow bank-to-bank transmission of funds to pay for merchant goods. Thus, a merchant's invoice may be satisfied when the financial intermediary transfers funds to the ACH and then notifies the merchant of the transfer.

According to an embodiment, a merchant may also register with a financial transaction system by installing software to a computing platform for recognizing consumers browsing a website using software installed on the consumers computing platform identifying (as illustrated below) such consumers as being registered to the financial transaction system. Upon such registration, a merchant may receive a database enabling processing of non-Internet orders from consumers using off-line catalogs. Also, such a merchant may also receive unique identifier (ID) that is contained within the computer software installed to the merchant's computing platform. It should be understood, however, that these are merely examples of software that may be installed on a merchant's computing platform, and claimed subject matter is not limited in these respects.

As illustrated above, a customer may provide an OVRT enabling a financial intermediary to notify a customer of the status of orders and/or other information. Here, for example, a financial intermediary may notify a customer of a completion or termination of a transaction, and any problems that may have arisen in the course of the transaction, by transmitting a message to the customer according to information in its OVRT. Such notification may be in the form of an automated reply via email or other Internet protocol, fax and/or a voice message, for example. A registered merchant may also provide an OVRT to the financial intermediary enabling receipt of information Like an OVRT of a customer, such a merchant may be associated with an Internet Protocol (IP) address and/or Internet domain name, for example. Again, these are merely examples of how an OVRT may be implemented and claimed subject matter is not limited in these respects.

During customer registration, a shipping address for the customer may be provided. Such a shipping address may indicate where items that are purchased by the customer are to be shipped. This can be different from a customer's billing address. The billing address may indicate where the financial intermediary should send bills relating to the customer's credit account. According to an embodiment, a financial transaction system may allow, by use of authentication using a password and User ID for example, one or more alternative addresses to be used for specific purchases. This may overcome a problem of having a billing address that is different from the shipping address. For example, a P.O. Box may be used, or some other temporary address, so that for instance, a customer may purchase airline tickets while traveling or when making a purchase to send to another address as a gift.

According to an embodiment, a history of purchases made by a customer using a financial transaction system may be maintained in a database stored on a computing platform operated by the customer. This may allow such a customer the convenience of determining information about what has been purchased, vender, price, etc. Also, the data may be maintained in a format (e.g., data fields separated by tab or comma) that may be exportable to record keeping software such as Quicken, Excel, FileMaker Pro or any program that accepts data in such a format.

As discussed above, customers and merchants may register to obtain an ID and password to be used in participating in the financial transaction system. Software installed on a customer's computing platform may operate in conjunction with well known browser programs to allow the customer to browse the Internet and make purchases using the financial transaction system. Such installed software may include one or more of the following modules and/or items of information:

plugins covering typical operating systems and browsers;

registration routine (as illustrated above);

routine for maintaining database logging purchases for the customer's use;

instructions for registration;

telephone dialing string software for initial registration (e.g. to a direct toll free line);

IP address, URL and/or domain name for use in contacting financial intermediary for registration;

offline website/catalogs featuring goods and/or services associated and/or registered with a financial intermediary;

credit card application for the financial intermediary;

applications to register with shipping companies; and

browser(s) which is adapted to dial direct any of the selected merchants via a toll free offline number.

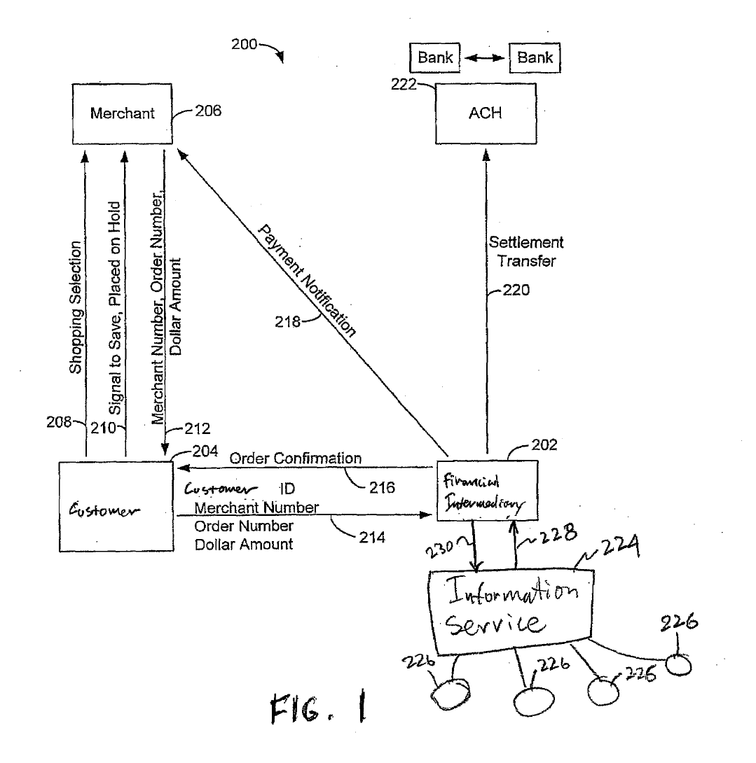

FIG. 1 is a schematic diagram of a financial transaction system 200 according to an embodiment. In a particular embodiment, although claimed subject matter is not limited in this respect, a financial intermediary 202, merchant 206 and customer 204 may operate and/or control computing platforms that are capable of communicating with one another over a communication network such as the Internet, for example. Accordingly, as referred to herein, the term “message” may relate to the transmission of information from a source to a destination using any one of several mediums such as, for example, a communication network such as the Internet and other IP infrastructure (e.g., email, HTTP, XML, etc.), dialup connection, facsimile transmission, person-to-person phone conversation, just to name a few.

As discussed above, credit financial intermediary 202 (e.g., credit card company or other credit provider) may provide software to a customer 204 to be loaded to customer's computing platform for implementing features of a financial transaction system. This may allow the customer to conduct financial transactions over the Internet or other data network, for example. Financial intermediary 202 may also authorize a subscribed merchant 206 to utilize the financial transaction system and issue software to merchant 206 for use in conjunction with merchant's interface to the financial transaction system. Here, for example, such software may be integrated with a website owned and/or operated by a merchant for selling goods and/or services. Here, merchant 206 may agree to accept payment from the financial intermediary via an ACH 222, which may perform bank to bank transfers for example. Once software is installed on computing platforms of both customer 204 and merchant 206, a financial transaction may be conducted as illustrated above.

The description below illustrates interactions between a customer's computing platform and a merchant's computing platform as inputs provided by the customer to a GUI on customer's computing platform which are received at a website operated and/or controlled by the merchant according to an HTTP protocol. Alternatively, however, computing platforms operated and/or controlled by a merchant and a customer may employ any one of several techniques to communicate such as, for example, dial-up modem-to-modem communication over phone lines, a Web service, email and/or other services supported by the Internet protocol. It should be understood, however, that these are merely examples, of how a customer's computing platform may communicate with a merchant's computing platform and claimed subject matter is not limited in this respect.

As illustrated below according to particular embodiments, a transaction between customer 204 and merchant 206 may be selectively terminated based, at least in part, on metadata which is descriptive of merchant 206. An information service 224 may obtain metadata regarding merchant 206 from one or more sources 226 according to an embodiment. In determining whether to complete or terminate a transaction, card center 202 may communicate with information service 224 to obtain metadata regarding merchant 206.

Such metadata obtained by a information service 224 may include, for example, information representative and/or indicative of products and/or services offered by merchant, location of merchant (e.g., state/country of incorporation, principle place of business and/or the like), solvency of merchant, rating of merchant by customers, uniqueness of product and/or service being offered, commoditization of product and/or service being offered, criminal history, a number of disputes involving merchant 206 and customers and/or financial intermediary 202, ties to criminal organizations and/or ties to terrorists organizations, to name a few. Sources 226 may comprise, for example, publicly available information such as information from government databases (e.g., filings with the Security and Exchange Commission, tax records, and/or the like). Other sources 226 may provide proprietary and/or paid services. Such other sources may include, for example, credit agencies, a trusted source that provides information regarding on-line merchants or other merchants, to name a few.

According to an embodiment, information service 224 may provide metadata regarding a merchant using a Web service, for example. Such a Web service may integrate application programs hosted by financial intermediary 202 and programs hosted by information service 224 using an Internet protocol (IP) infrastructure. In particular examples, although claimed subject matter is not limited in these respects, such a Web service may employ standard communication protocols to transmit data objects among component applications over an Internet protocol such as, for example, HTTP, HTTPS, XML, SOAP, WSDL and/or UDDI standards. Here, XML may be used to tag data objects, SOAP may be used to transfer data objects, WSDL may be used to describe available services and UDDI may be used to list available services. However, these are merely examples of protocols that may enable a Web service and claimed subject matter is not limited in these respects.

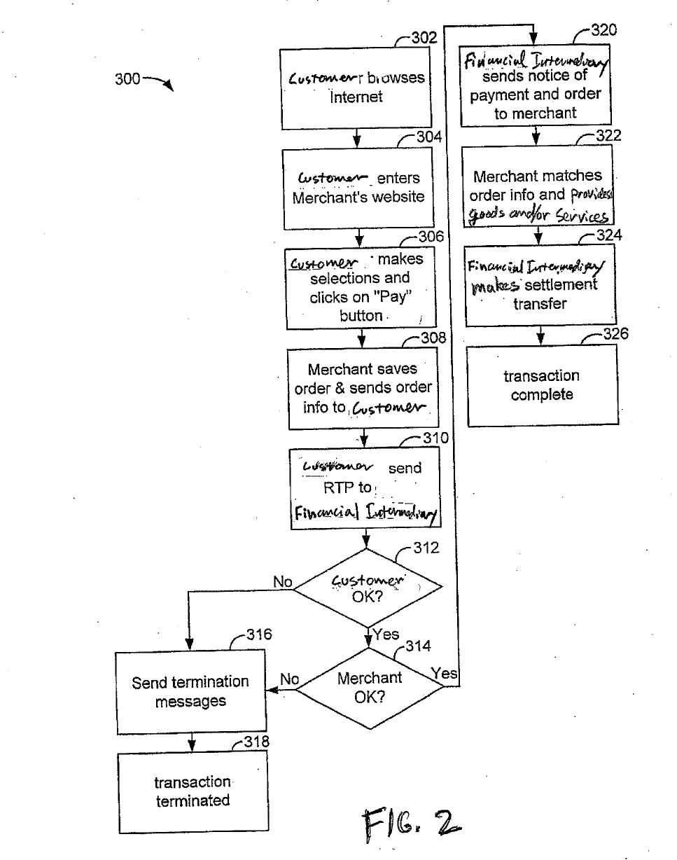

FIG. 2 is a flow diagram illustrating a process 300 of conducting a financial transaction using a financial transaction system such as financial transaction system 200, for example, to enable secure financial transactions among a customer, merchant and financial intermediary. At block 302, a customer may browse the Internet using a browser program. In one embodiment, as pointed out above, software loaded to such a customer's computing platform may operate as a plug-in for such a browser.

At block 304, a customer may communicate with a merchant's website, which may be in communication with software installed on a merchant's computing platform and provided by the financial transaction system as illustrated above. Here, the merchant's website may recognize the customer's browser software, and thus identify the customer as a member of and/or participant in the financial transaction system. For example, in one embodiment, the customer's browser may transmit special codes and/or information upon entering the merchant's website. Such codes and/or information may be interpreted by the software installed on the merchant's system to determine that the customer is registered with the financial transaction system. In another embodiment, the merchant's computing platform may transmit special codes and/or information to the customer's computing platform, which can be interpreted at the customer's computing platform. The customer's computing platform may then respond to the merchant's system, resulting in both computing platforms acknowledging membership in the financial transaction system.

At block 306, a customer may select one or more products or services for purchase from the merchant's website. In a particular example as illustrated with financial transaction system 200, this may be shown by message 208 in FIG. 1. For example, the website may provide a virtual shopping cart to maintain a record of customer selections. At some point, the customer may desire to purchase the items in the shopping cart, and click on a “button” on a GUI, for example, which may read, “pay by financial transaction system,” for example. Again in the particular example of financial transaction system 200, this may shown by message 210.

At block 308, a merchant's computing platform may save customer's order in a merchant database. The merchant's computing platform may then create a purchase order containing the merchant's ID, a unique order number for the purchase, a dollar amount for the purchase, and identification data such as the merchant's email address, domain name, etc. In the particular example of financial transaction system 200 as illustrated in FIG. 1, such a purchase order may be transmitted to the customer's computing platform in message 212, and stored in a database on customer 204's computing platform. In essence, although not necessarily in all embodiments, the purchase order may act as merchant's offer to sell the selected items to customer. In alternative embodiments, however, receipt of such a purchase order does not necessarily constitute a legal “offer” to form a binding contract.

At block 310, in a particular embodiment, a customer's browser may “tickle” a merchant Website to keep an Internet session active. In the meantime, customer's browser may transmit a request to pay (RTP) to the financial intermediary's system, shown as message 214 in the particular embodiment of financial transaction system 200 shown in FIG. 1. Such an RTP may include purchase order data from a merchant and a customer's unique ID and password, for example. At blocks 312 and 314, a RTP and the purchase order may be processed by a financial intermediary. Here, a computing platform may perform two tests. A first test, at block 312, may determine whether customer is authorized to make the requested purchase. For example, block 312 may determine whether the customer has enough credit available to pay for the selected items using a non-cash transaction. A second test, at block 314, may determine whether the merchant is authorized to participate in this transaction. For example, is the merchant a registered merchant in good standing.

At block 316, if either test fails, a financial transaction system may reply to predetermined OVRT addresses with an appropriate message for both merchant and customer. For example, one message may go to a customer to state that there is not enough credit available to make the requested purchase. A second message may go to the merchant to state that the customer is unable to complete the transaction. The merchant may also receive a message indicating that the transaction was terminated since the merchant is not a member of the financial transaction system. The merchant's OVRT may be provided during merchant registration or included in the purchase order information sent to the financial intermediary. Once the messages are sent, the transaction is terminated as shown at block 318.

At block 320, if both tests at blocks 312 and 314 pass, the financial intermediary system may reply to predetermined OVRT addresses with an appropriate message to both customer and merchant. In the particular embodiment of financial transaction system 200 shown in FIG. 1, a message 216 to customer 204 may comprise an order confirmation number or other indication that the order is to be placed. A message 218 to merchant 206 may include a unique order number and a pre-registered shipping address or an authorized alternate shipping address, for example. The financial intermediary may also notify the merchant that payment has been made to the ACH used to transfer funds between financial intermediary 202 and the merchant 206.

At diamond 314, according to a particular embodiment, card center 202 may determine whether or not to terminate a transaction at block 316 based, at least in part, on information received from information service. In the particular embodiment of financial transaction system 200 as illustrated in FIG. 1, for example, in response to receiving RTP message 214, financial intermediary 202 may issue a query 230 to information service 224 including information such as, for example, information in RTP message 214. Information service 224 may then provide a response 228 to query 230 including, for example, metadata regarding merchant 206. Here, query 230 may identify a merchant by ID, good and/or service that is the subject of the transaction, dollar amount of the transaction, volume, and/or the like. As illustrated below according to particular embodiments, card center 202 may determine whether the transaction is to complete (e.g., by proceeding to transmit a payment notification message 218 at block 320) based, at least in part, on metadata provided by response 228. Alternatively, response 228 may comprise a suggestion as to whether the transaction should be allowed to complete or whether the transaction should be terminated. Here, for example, information service 224 may make such a determination based, at least in part, on metadata associated with merchant 202 as illustrated below.

In an alternative embodiment, financial intermediary 202 may maintain a database (not shown) of metadata concerning merchants registered with the financial transaction system and information service 224 may provide periodic updates to financial intermediary 202. Financial intermediary 202 may then determine whether to complete or terminate a transaction based, at least in part, on metadata regarding merchants without issuing a query to information service 224 upon receiving RTP message 214. However, it should be understood that this is merely an alternative to how a transaction intermediary may determine whether to complete or terminate a transaction based, at least in part, on metadata concerning a merchant and claimed subject matter is not limited in these respects.

At block 322, a merchant may match order information contained in a received OVRT with order information contained in a database maintained by the merchant. If the information matches, the merchant may ship the order to a specified address. In an alternative embodiment, the merchant may not have access to address information associated with a destination of a customer's purchased goods. Here, a shipping party (not shown) may merely receive goods from the merchant with order information. The shipping party may then associated the order information with location to deliver the purchased goods.

In the particular embodiment of financial transaction system 200, for example, at block 324, financial intermediary 202 may collect payment from customer 204 and forward payment to merchant 206 via a settlement transfer to the ACH 222, as shown at message 220. In one particular embodiment, although claimed subject matter is not limited in this respect, once the settlement transfer is made, the transaction is complete as shown at block 326.

As a result of performing a financial transaction in accordance with process 300, a customer's credit card number or other personal information need not be transmitted over a data transmission network. This prevents theft of customer's personal information. An additional level of security is provided since the merchant never has access to the credit card number or other personal information. Therefore, corruption or lack of security at the merchant's site will have no effect on the security of the customer's personal information.

Transfer of funds from a financial intermediary to the merchant may be performed using any one of several methods of transferring funds. In the above embodiment, the transfer occurred using an ACH. Since the transfer of funds is secondary, claimed subject matter is not limited in this respect as it is possible to transfer funds in other ways by, for example, wiring funds directly to a merchant's account.

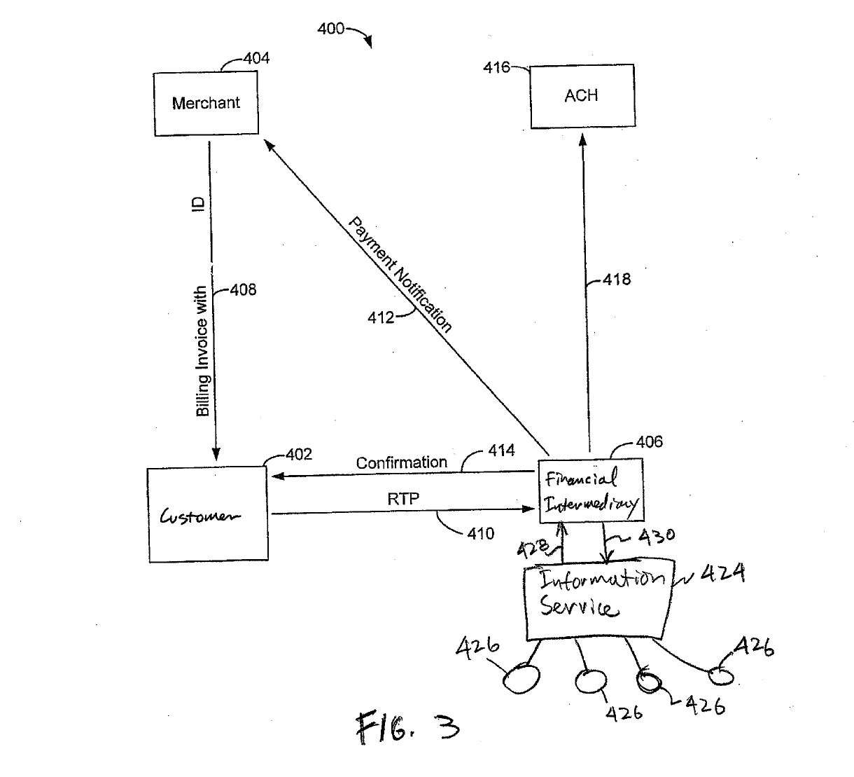

In another embodiment, although claimed subject matter is not limited in this respect, an invoice paying system is provided, wherein a customer can make payments to merchants and/or service providers and/or other entities registered with a financial transaction system. FIG. 3 shows an invoice paying system 400 (or bill paying system) for paying invoices for goods and/or services in accordance with an embodiment. System 400 may allow a customer 402 to pay an invoice from a merchant 404 via a financial intermediary 406. As illustrated above in financial transaction system 200 with reference to FIG. 1, financial intermediary 406 may selectively terminate such transactions or allow such transactions to complete based, at least in part, on metadata regarding merchant 404 which is collected at information service 424 from sources 426.

FIG. 4 is a flow diagram illustrating a process 500 for conducting a financial transaction for use with an invoice paying system such as invoice paying system 400 shown in FIG. 3, for example. Here, a merchant and customer may be registered with a financial transaction system as illustrated above.

At block 502, a customer may receive an invoice for goods and/or services from a merchant. Such an invoice may be received via electronic means, such as email, Web service or as a delivered hardcopy and may contain a merchant's ID number along with other relevant billing information. In the particular embodiment of invoice paying system 400, such and invoice may be provided in message 408, for example. At block 504, a customer may enter a merchant's ID information and billing information into his or her own computing platform having software for the financial transaction system installed thereon as discussed above. At block 506, the customer may transmit this information to financial intermediary along with an RTP message. In the particular embodiment of invoice paying system 410, for example, this RTP message may comprise RTP message 410. At diamond 508, a financial intermediary may verify that a customer has sufficient credit available in a credit account to pay the merchant invoice identified in an RTP message such as RTP message 410 for example.

At diamond 510, a financial intermediary may verify that a merchant is registered with financial transaction system and is eligible to receive payments accordingly. As illustrated above according to the particular embodiments, financial intermediary 406 may selectively terminate a payment transaction or allow such a payment transaction to complete based, at least in part, on metadata concerning merchant 404 collected by information service 424. As illustrated above, financial intermediary 406 may selectively terminate the transaction based, at least in part, on a response 428 to a query 430 to information service 424 including information such as information provided in an RTP message 410. Here, such a query 430 may identify a merchant by ID associated with merchant, good and/or service to be provided in the transaction, amount of payment, volume, and/or the like. Alternatively, also as illustrated above, financial intermediary 406 may maintain a database of metadata concerning merchants registered with a financial transaction system that is periodically updated by information service 424.

At block 512, if the checks performed at diamonds 508 and 510 fail, then a message may be sent to a customer indicating that the invoice cannot be paid by the financial transaction system. The transaction may then terminated as shown at block 514. A message need not be sent to a merchant providing a good and/or service since the merchant may not even be aware that customer is attempting to pay the invoice via the financial transaction system.

At block 516, if the checks at diamonds 508 and 510 pass, a financial intermediary may notify a merchant that payment has been made on behalf of customer 402 for an invoice amount. In the particular embodiment of invoice paying system 400, this may be shown at message 412 for example. Here, such a notification may be provided to customer 404 initiating the transaction and/or to a central computing platform associated with customer 402. Financial intermediary 406 may then transfer funds to the ACH 416 agreed to by merchant 404 and financial intermediary 406 via message 418.

At block 518, a financial intermediary 406 may transmit a confirmation indicating that a merchant has been paid. In the particular embodiment of invoice paying system 400, this may be shown as message 414. At block 520, the transaction may be completed and the customer can record in a payment log that the invoice has been paid. Here, a merchant may send the purchased items to a customer which may include an account statement for customer's records, for example.

In business situations, the invoice paying system may allow a customer to make repeat orders or orders as needed, rather than having to cancel a standing automatic recurring system order. Professional services that don't have a website, for example, but wish to take credit card payments, can do so using the invoice paying system described herein. For example, if a customer obtains a service provider's ID number associated with the financial transaction system and invoice information from a bill mailed to the customer, the customer can still arrange for payments to be made via the financial transaction system with notification sent to the merchant via telephone, e-mail, a Web service, mail or fax systems.

According to an embodiment, although claimed subject matter is not limited in this respect a financial transaction system may provide for purchasing goods and/or services from catalogs published by merchants. Such catalogs may be in the form of hardcopy, electronically downloaded merchant catalogs, web pages, magazine advertisement or television advertisement, just to name a few examples. Thus, a customer can view the catalog information in an off-line mode, e.g. when not connected to a merchant's website, and purchase selected goods or services. When downloaded as web pages, the catalogs may be fully functional and operate in the same manner as if the customer was connected on-line to the merchant's website.

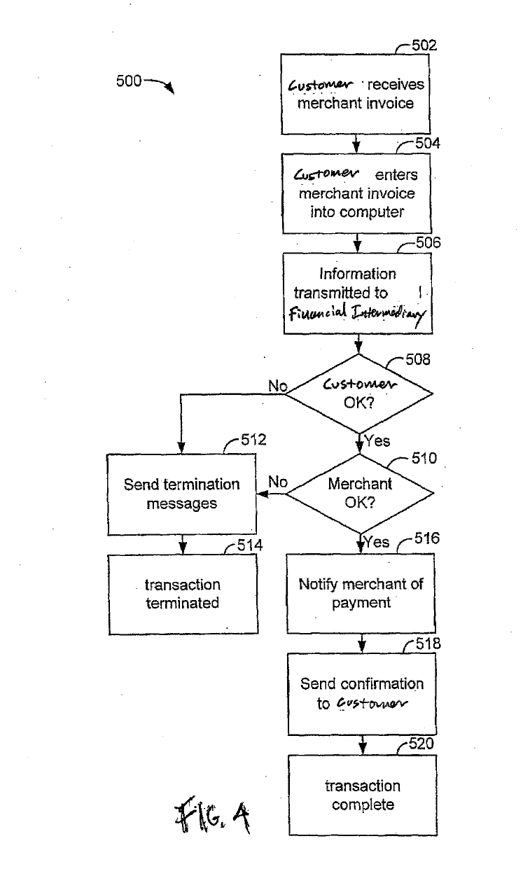

FIG. 5 is a schematic diagram of a financial transaction system 600 for purchasing goods and services off-line according to an embodiment. A merchant 602 provides catalog information 601 about available goods or services to a customer 604. Customer 604 may make purchases from the catalog 601 using a financial transaction system provided by financial intermediary 606, for example. An ACH 622 may make bank to bank transfers allowing financial intermediary 606 to transfer funds to merchant 602 on behalf of customer 604. As illustrated above in financial transaction system 200 with reference to FIG. 1 and in invoice paying system 400 with reference to FIG. 3, financial intermediary 606 may selectively terminate transactions based, at least in part, on metadata regarding merchant 404 which is collected at information service 624 from sources 626.

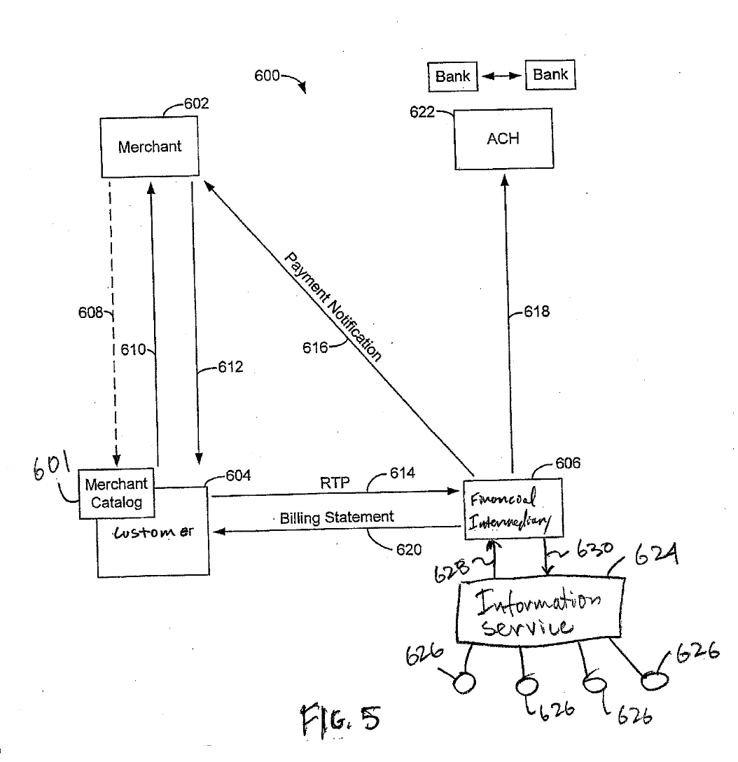

FIG. 6 is a flow diagram illustrating a process 700 for conducting a financial transaction using a financial transaction system such as financial transaction system 600 shown in FIG. 5, for example. At block 702, a customer may receive a catalog from a merchant. In the particular embodiment illustrated above in FIG. 5, this may be shown as communication 608. Here, customer 604 may obtain catalog 601 in any one of several forms such as, for example, a hardcopy catalog to the customer via regular mail, other mail delivery, facsimile service and/or the like. Merchant 602 may also transmit a softcopy of catalog 601 to customer 604's computing platform via email and/or other electronic transmission means. It some embodiments, customer 604 may communicate with a website being operated by merchant 602 to selectably download catalog 601 from the merchant's website to the customer 604's computing platform for later viewing. Catalog 601 may also comprise an off-line version of a website operated by merchant 602. It should be understood, however, that these are merely examples of how a customer may obtain a version of a catalog and claimed subject matter is not limited in this respect.

According to an embodiment, a catalog obtained at block 702 may include information identifying goods and/or services offered by a merchant, prices associated with such goods and/or services, related shipping services available, other costs and/or the like. Such a catalog may also comprise an ID associated with a merchant as a participant in a financial transaction system and other merchant profile information.

At block 704, a customer may review a catalog off-line. For example, the customer may read a hardcopy version of the catalog hen away from his or her computing platform, or may view an electronic version of the catalog on his or her computing platform when not connected to a merchant's on-line system (e.g., through a website operated by the merchant). While viewing an electronic version of a catalog off-line, according to an embodiment, a customer may select items for purchase and click on a “buy” button, from a GUI for example, to begin the purchase process. While viewing a hardcopy version of a catalog, according to a different embodiment, a customer 604 may select items for purchase and enter associated information to identify the selected items, a merchant's ID, a phone number to contact the merchant, and any other related information into software installed on customer's computing platform. Alternatively, the customer may make selections using other techniques such as placing an order with a telephone call center operated by a merchant. It should be understood, however, that these are merely examples of how a customer may make a selection from a catalog and claimed subject matter is not limited in these respects.

At block 706, after a customer has made selections as illustrated above, the customer's computing platform may contact a merchant by, for example, activating a dialing string on a modem which dials a phone number designated by the merchant to take digital orders, sending an email message or transmission of a message using a different communication protocol. In the particular embodiment of financial transaction system 600, contact may be shown as message 610. Here, software installed on merchant 602's computing platform may obtain purchase data from customer 604's computing platform, which may be in the form of delimited text for example, and store the received purchase data in merchant 602's database. Optionally, the merchant 602's computing platform may check for inventory levels and/or price changes. If items are out of stock or there has been a price change, software installed on merchant 602's computing platform may reply to customer 604 to give customer 604 the option to revise the order or to proceed. Merchant 602 may have the option to terminate the call and prompt customer 604 to resubmit the order when the changes have been made or to maintain a communication session while customer 604 revises the order.

In another embodiment, when a customer makes a selection from a computing platform to purchase (e.g., by selecting a “buy” button in a GUI of customer 604's computing platform is clicked on), the computing platform may be directed to the merchant's website on the data network. Upon establishing communication between customer 604's computing platform and the merchant 602's website, information exchanged between the merchant and the customer may be performed over data transmission network.

At block 708, a merchant's computing platform may create a purchase order containing the merchant's ID, a unique order number for the purchase, a dollar amount for the purchase price, and other data such as the merchant 602's email address, URL and/or the like. In the particular embodiment of financial transaction system 600, such a purchase order may be transmitted to the customer 604's computing platform in message 612, and stored in a database on the customer 604's computing platform.

At block 710, a customer's computing platform may transmit an RTP message to financial intermediary. In the particular embodiment of financial transaction system 600, such an RTP message may be transmitted in message 614 and may be transmitted over a direct telephone connection or other data transmission means to a computing platform operated by financial intermediary 606, for example. Such an RTP may include purchase order data from a merchant and a customer's ID and password. Alternatively, the RTP may also include other information, such as customer survey information, wherein the customer recommends other merchants that may be part of financial transaction system 600. However, this is merely an example of information that may be provided in an RTP and how such an RTP may be transmitted to a financial intermediary, and claimed subject matter is not limited in these respects.

At block 712, a financial intermediary may determine whether a received RTP message is from a customer that is registered member of and/or participant in a financial transaction system such as financial transaction system 600. Such a financial intermediary, according to a particular embodiment, may also review information regarding the requested purchase and determine whether the customer has sufficient funds and/or credit to cover the cost of the requested items, for example.

At block 714, a financial intermediary may determine whether a merchant's ID belongs to a registered member of and/or participant in a financial transaction system such as financial transaction system 600. As illustrated above according to the particular embodiments of FIGS. 2 and 4, a financial intermediary may selectively terminate the transaction based, at least in part, on metadata concerning merchant 604 collected by information service 624. Here, and as illustrated above, financial intermediary 606 may selectively terminate the transaction based, at least in part, on a response 628 to a query 630 including information such as information provided in RTP message 614. In one embodiment, although claimed subject matter is not limited in this respect, query 630 may identify a merchant by ID, good and/or service that is the subject of the transaction, dollar amount of the transaction, volume, and/or the like. Alternatively, also as illustrated above, financial intermediary 606 may maintain a database of metadata concerning merchants registered with financial transaction system 600 that is periodically updated by information service 624.

At block 716, if either customer 604 or merchant 602 fail checks performed in diamonds 712 and 714, then a termination message may be sent from financial intermediary 606 to customer 604. Such a termination message may indicate to customer 604 why the requested transaction was terminated. At block 718, after the termination message is sent, the attempted transaction is terminated.

At block 720, if both checks at diamonds 712 and 714 pass, then a financial intermediary may create a purchase order to transmit to the merchant. In the particular embodiment of financial transaction system 600 illustrated above, such a purchase order may contain information about the items to be purchased, shipping information and payment notification. In the particular embodiment of financial transaction system 600, for example, such a purchase order may be transmitted with a payment notification in message 616. Contemporaneous, financial intermediary 606 may communicate with ACH 620 to transfer payment to the merchant in message 618.

At block 722, an order confirmation sent from a financial intermediary may inform a customer that the order has been placed. Here, in the particular embodiment of financial transaction system 600, such an order confirmation may be provided through message 620.

At block 724, a merchant may ship the requested items to a customer. At block 726, the customer may receive the items requested and the transaction is completed.

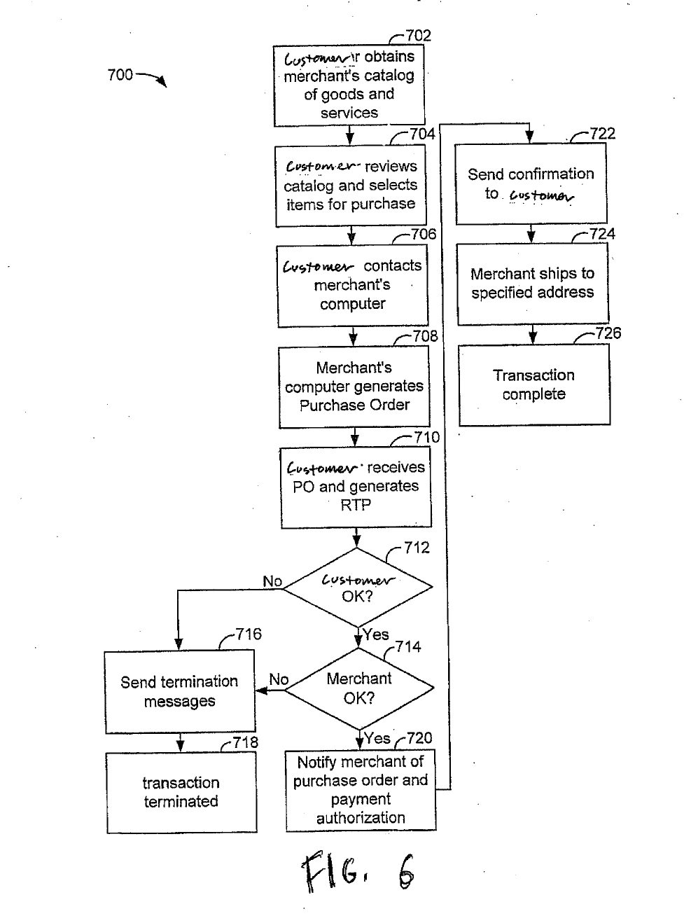

As illustrated above according to particular embodiments, a financial intermediary (e.g., a financial intermediary and/or card center as discussed above with reference to FIGS. 1, 3 and 5) may selectively terminate a transaction based, at least in part, on metadata regarding a merchant that is to provide a good and/or a service under the transaction. FIG. 7 is a flow diagram illustrating a process 800 of determining whether a transaction is to be completed based, at least in part, on metadata concerning a merchant according to a particular embodiment. Depending on a particular implementation, process 800 may be executed in whole or in part at a financial intermediary or service such as a card company and/or card transaction processing center. Block 802 may obtain a customer profile which is descriptive and/or indicative of a customer attempting to purchase a good and/or service from a merchant as illustrated above. Such a customer profile may be indicative of a customer's tolerance for certain risks such as, for example, late delivery of certain goods and/or services, non-delivery of goods and/or services under a purported transaction. However, these are merely examples of information that may be used to make up a customer profile and claimed subject matter is not limited in this respect. Such a customer profile may be stored in a database, for example, that is updated and maintained by a financial intermediary such as a financial intermediary. However, customer profile information may be obtained from other sources and claimed subject matter is not limited in these respects.

Block 804 may obtain metadata regarding a merchant from any one of several sources such as, for example, an information service such as illustrated above. Also as illustrated above, such metadata may be collected from one or more sources including private information sources and/or public information sources and may include metadata descriptive and/or indicative of, for example, products and/or services offered by merchant, location of merchant (e.g., state/country of incorporation, principle place of business and/or the like), solvency of merchant, rating of merchant by customers, statistics involving frequency of disputes between merchant and customers and/or financial intermediaries, uniqueness of product and/or service being offered, commoditization of product and/or service being offered, criminal history, ties to criminal organizations and/or ties to terrorists organizations. It should be understood, however, that these are merely examples of metadata regarding a merchant and that claimed subject matter is not limited in these respects.

Block 806 may employ any one of several techniques to determine whether a transaction should be terminated or allowed to complete based, at least in part, on metadata regarding a merchant that is to provide a good and/or service under the transaction. In one particular embodiment, block may employ one or more heuristic rules based, at least in part, on metadata regarding a merchant obtained at block 804 and a customer profile obtained at block 802. In one example, a first score based upon one or more items of the metadata may be compared with a second score representing a customer's tolerance for risk. If the first score exceeds the second score, according to a particular embodiment, block 806 may determine that a transaction is to be terminated. However, this is merely an example of a heuristic rule that may be implemented to determine whether a transaction should be terminated or allowed to complete and claimed subject matter is not limited in this respect.

FIG. 8 is a schematic diagram of a computing platform 1000 suitable for use in embodiments of the financial transaction system. For example, such a computing platform may be operated by a customer, seller, merchant and/or financial intermediary to facilitate transactions as illustrated above. Here, computing platform 1000 may include display 1002 having display screen 1004, cabinet 1006 to house computer components (not shown) such as a disk drive, CDROM drive, display adapter, network card, random access memory (RAM), central processing unit (CPU), and other components, subsystems and devices, to name a few. User input devices such as a mouse 1008 having buttons 1010, and a keyboard 1012 are shown. Other user input devices such as a trackball, touch-screen, digitizing tablet, however, can be used. It should be understood that computing platform 1000 is merely illustrative of one particular type of computing platform, such as a desktop computer, suitable for use as illustrated above in connection with particular embodiments, and that other types of computing platforms may be used without deviating from claimed subject matter.

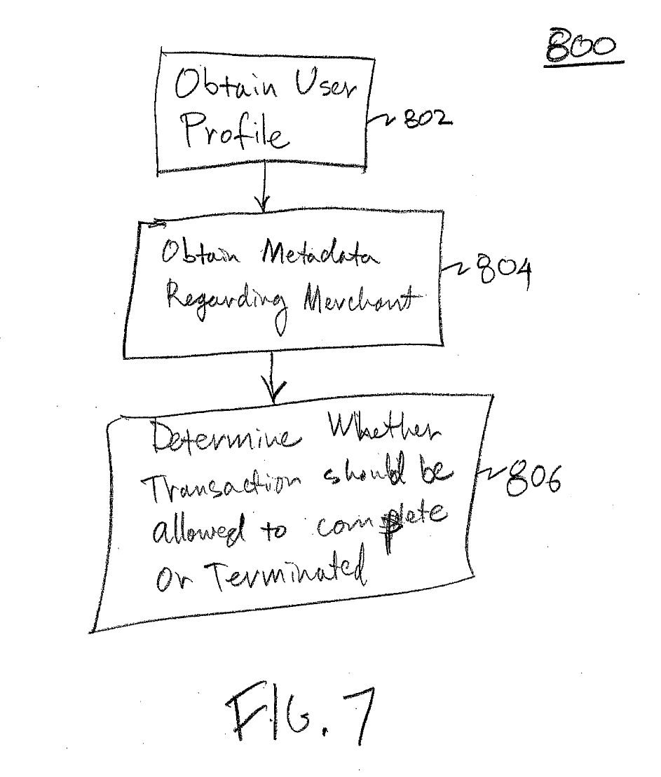

FIG. 9 is a schematic diagram of subsystems of a computing platform such as computing platform 1000 according to a particular embodiment. Subsystems within box 1006 may communicate via an internal bus 1110. Such subsystems may include input/output (I/O) controller 1112, random access memory (RAM) 1114, central processing unit (CPU) 1116, display adapter 1118, serial port 1120, fixed disk 1122 and network interface adapter 1124. Bus 1110 may allow subsystems to transfer data among the subsystems and with CPU 1116. External devices such as monitor 1126, relative pointing device (RPD) 1128 and keyboard 1130 may communicate with the CPU or other subsystems via bus 1110.

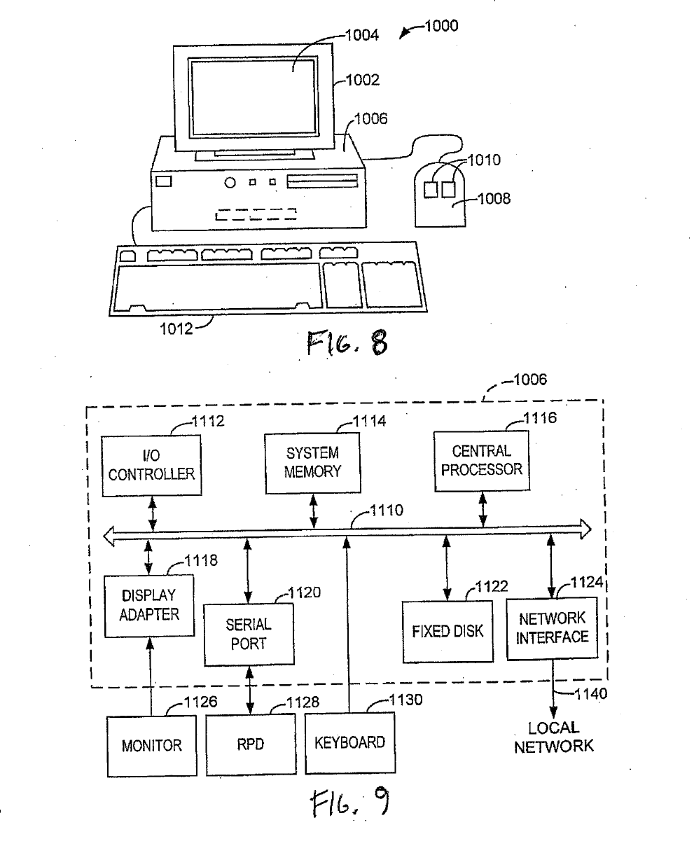

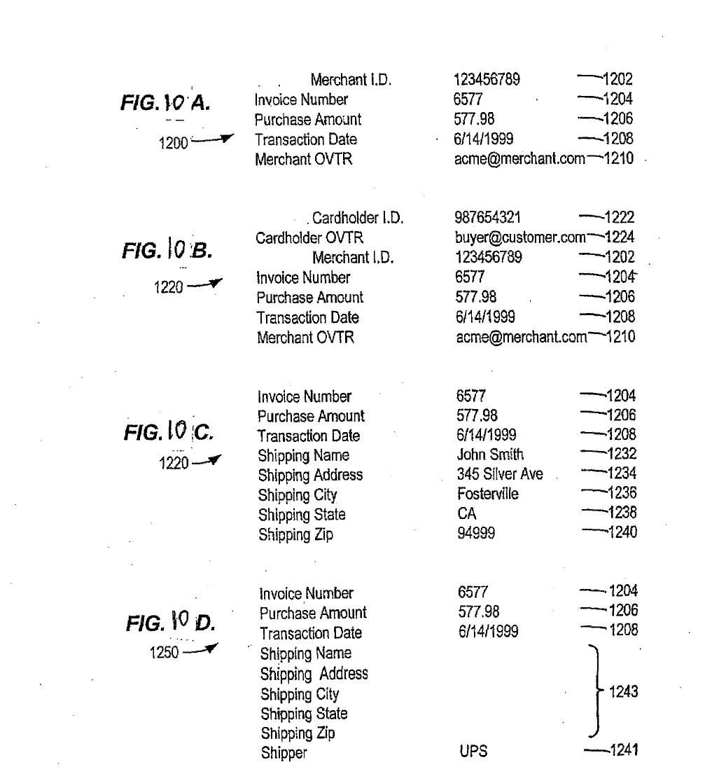

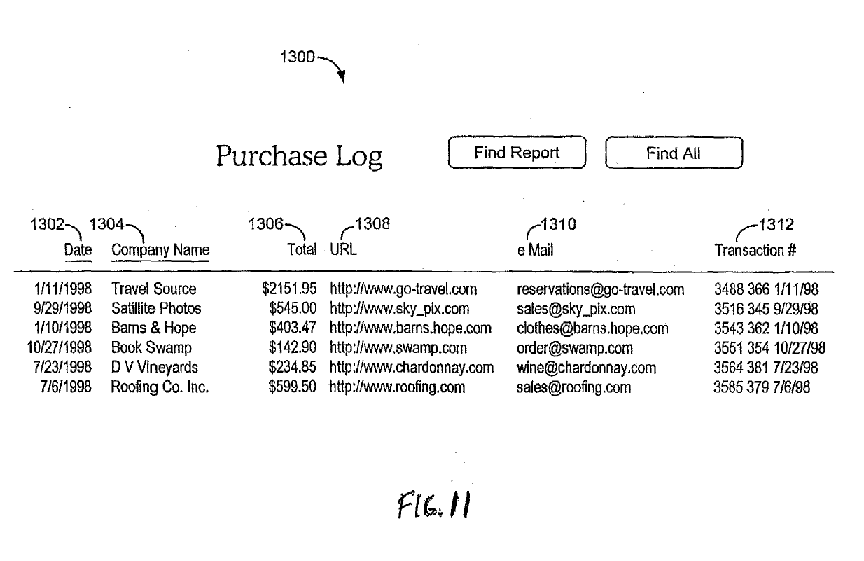

FIGS. 10A-10D show exemplary data formats which may be used during financial transactions described in the above embodiments.

FIG. 10A shows a data format 1200 for information transmitted from a merchant to a customer during operation of an embodiment of a financial transaction system as illustrated above. Data format 1200 includes a merchant ID 1202, an order number 1204, a purchase amount 1206, a transaction data 1208 and a merchant OVTR 1210. Other information in connection with a financial transaction may be included, however. Data format 1200 is intended to be an exemplary list of data items that may be transmitted from a merchant to a customer during operation of a financial transaction system, and claimed subject matter is not limited in this respect.

FIG. 10B shows a data format 1220 for information transmitted from a customer to a financial intermediary during operation of embodiments of a financial transaction system as illustrated above. Data format 1220 includes a customer ID 1222 and a customer OVTR 1224. Other information in connection with a financial transaction may be included, however. Data format 1220 is intended to be an exemplary list data items that may be transmitted from a customer to a financial intermediary during operation of a financial transaction system, and claimed subject matter is not limited in this respect.

FIG. 10C shows a data format 1230 for information transmitted from a financial intermediary to a merchant during operation of embodiments of a financial transaction system as illustrated above. Data format 1230 may include an order number 1204, purchase amount 1206 and transaction date 1208. Additional information such as a shipping name 1232, a shipping address 1234, a shipping state 1236, a shipping state 1238 and a shipping zip code 1240 may also be included. Other information in connection with a financial transaction may be included, however. Data format 1230 is intended to be an exemplary list of data items that may be transmitted from a financial intermediary to a merchant during operation of a financial transaction system, and claimed subject matter is not limited in these respects.

FIG. 10D shows a data format 1250 for information transmitted from a financial intermediary to a merchant during operation of embodiments of a financial transaction system as illustrated above. Data format 1250 may include an order number 1204, purchase amount 1206 and transaction date 1208. In a particular embodiment, information 1243, relating to a customer's shipping information, can be omitted so that such information given to the merchant only identifies the purchase that has been paid for. Data format 1250 may also include a shipper identifier 1241, so that the merchant is notified of a third party shipper that will handle shipping the purchase to the customer. The customer's shipping information may be given to the third party shipper and may be kept confidential from the merchant, for example. Other information relating to the financial transaction may be included, however. Data format 1250 is intended to be an exemplary list of data items that may be transmitted from a financial intermediary to a merchant during operation of a financial transaction system, and claimed subject matter is not limited in this respect.

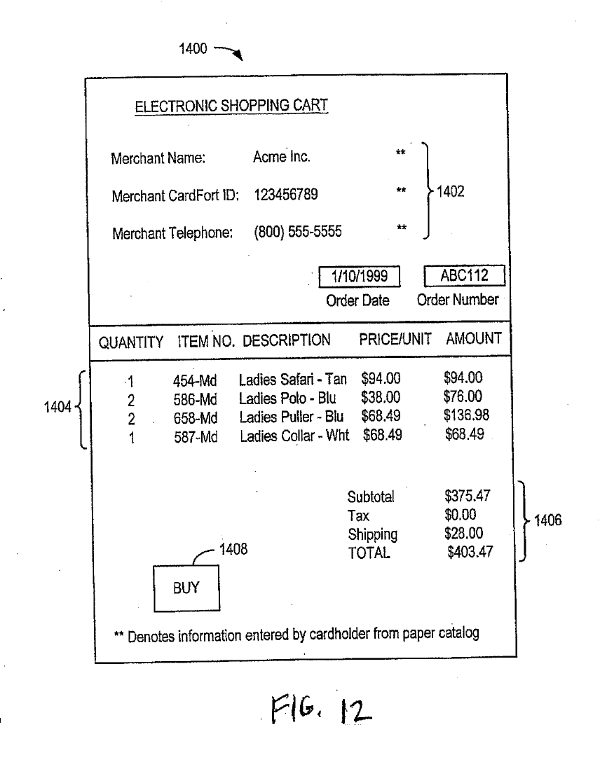

FIG. 11 shows an exemplary purchase log 1300 that may be employed with a financial transaction system as illustrated above and stored on a customer's computing platform. Purchase log 1300 includes a transaction date 1302, a merchant (company name) 1304 and a purchase amount 1306. Purchase log 1300 may also include a merchant URL 1308 or merchant email address 1310, which can be part of the merchant's OVRT. A transaction number 1312 may also be included in purchase log 1300 to enable a customer to reference a particular transaction by transaction number 1312. Other information relating to financial transactions may be included in a purchase log, however. Purchase log 1300 is intended to be an exemplary list of data items that may be included in a purchase log and claimed subject matter is not limited in these respects. A similar purchase log may be maintained by a merchant or financial intermediary. Thus, all parties to a particular transaction may maintain log information, and thereby store a history of financial transaction information.

FIG. 12 shows an exemplary electronic shopping cart 1400 which may be displayed in conjunction with a graphical user interface (GUI) of a computing platform operated by a customer. Here, electronic shopping cart 1400 may enable a customer to enter goods for purchase from a merchant. According to particular embodiments, although claimed subject matter is not limited in these respects, electronic shopping cart 1400 may be used in both on-line and off-line operating modes. For example, when a customer is connected to a merchant's web site, the merchant information, as shown at 1402, may be automatically inserted. If an off-line catalog electronic catalog from the merchant is used, the merchant information 1402 may also be automatically inserted. However, if a hardcopy of a merchant catalog is being used, the customer may manually enter merchant information 1402 into electronic shopping cart 1400.

As a selection is entered, item information, shown at 1404, may be entered into the electronic shopping cart. A total is provided at 1406. When the customer has completed making item selections, a buy button 1408, may be clicked on to start the financial transaction as provided in particular embodiments. Therefore, the electronic shopping cart 1400 can be used in both on-line and off-line applications to select item for purchase from a merchant and to activate a financial transaction in accordance with the present invention.

While there has been illustrated and described what are presently considered to be example embodiments, it will be understood by those skilled in the art that various other modifications may be made, and equivalents may be substituted, without departing from the claimed subject matter. Additionally, many modifications may be made to adapt a particular situation to the teachings of the claimed subject matter without departing from the central concept described herein. Therefore, it is intended that the claimed subject matter not be limited to the particular embodiments disclosed, but that such claimed subject matter may also include all embodiments falling within the scope of the appended claims, and equivalents thereof.

What is claimed is:

1. A method comprising:
receiving information from a customer, said information being associated with said customer and an order for a transaction for a purchase of a good and/or service from a seller;
receiving metadata associated with said seller from a service other than said customer; and
selectively transmitting a payment notification to said seller for completion of said transaction based, at least in part, on metadata associated with said seller.

2. The method of claim 1, and further comprising inhibiting said transmission of said payment notification based, at least in part, on a risk profile associated with said customer.

3. The method of claim 2, and further comprising:
determining a first score based, at least in part, on said metadata; and
determining a second score based, at least in part, on said risk profile,
wherein said selectively transmitting a payment notification to said seller further comprises selectively transmitting said payment notification based, at least in part, on a comparison of said first and second scores.

4. The method of claim 1, and further comprising selectively terminating said transaction based, at least in part, on said metadata.

5. The method of claim 4, wherein said selectively terminating said transaction further comprises transmitting a termination message to said customer.

6. The method of claim 5, wherein said selectively terminating said transaction further comprises transmitting a termination message to said seller.

7. The method of claim 1, wherein said metadata associated with said seller comprises information descriptive of goods and/or services available by said seller.

8. The method of claim 1, wherein said metadata associated with said seller comprises information descriptive of a location of said seller.

9. The method of claim 1, wherein said metadata further comprises an indication as to whether said seller is associated with a party on a criminal watch list.

10. The method of claim 1, wherein said metadata further comprises information indicative of a degree of commoditization of at least one good and/or service offered by said seller.

11. The method of claim 1, and further comprising determining whether to complete said transaction based, at least in part, on a comparison of said metadata and a risk profile associated with said consumer.

12. The method of claim 1, and further comprising receiving said metadata from a trusted source.

13. The method of claim 1, wherein at least a portion of said metadata is derived from a government database.

14. The method of claim 1, wherein said service comprises a Web service.

15. The method of claim 1, wherein said seller comprises a merchant of said good and/or service.

16. The method of claim 15, and further comprising adjusting a credit and/or debit account associated with said customer in response to completion of said transaction.

17. An apparatus comprising:
a computing platform, said computing platform being adapted to:
receive information from a customer, said information being associated with said customer and an order for a transaction for a purchase of a good and/or service from a seller;
receive metadata associated with said seller from a service other than said customer; and
selectively transmit a payment notification to said seller for completion of said transaction based, at least in part, on metadata associated with said seller.

18. The apparatus of claim 17, wherein said computing platform is further adapted to inhibit said transmission of said payment notification based, at least in part, on a risk profile associated with said customer.

19. The apparatus of claim 18, wherein said computing platform is further adapted to:
determine a first score based, at least in part, on said metadata;
determine a second score based, at least in part, on said risk profile; and
selectively transmit said a payment notification based, at least in part, on a comparison of said first and second scores.

20. The apparatus of claim 17, wherein said computing platform is further adapted to selectively terminate said transaction based, at least in part, on said metadata.

21. The apparatus of claim 20, wherein said computing platform is further adapted to selectively terminate said transaction by transmitting a termination message to said customer.

22. The apparatus of claim 21, wherein said computing platform is further adapted to selectively terminate said transaction by transmitting a termination message to said seller.

23. The apparatus of claim 17, wherein said metadata associated with said seller comprises information descriptive of goods and/or services available by said seller.

24. The apparatus of claim 17, wherein said metadata associated with said seller comprises information descriptive of a location of said seller.

25. The apparatus of claim 17, wherein said metadata further comprises an indication as to whether said seller is associated with a party on a criminal watch list.

26. The apparatus of claim 17, wherein said metadata further comprises information indicative of a degree of commoditization of at least one good and/or service offered by said seller.

27. The apparatus of claim 17, wherein said computing platform is further adapted to determining whether to complete said transaction based, at least in part, on a comparison of said metadata and a risk profile associated with said consumer.

28. The apparatus of claim 17, wherein said metadata is provided by a trusted source.

29. The apparatus of claim 17, wherein at least a portion of said metadata is derived from a government database.

30. The apparatus of claim 17, wherein said service comprises a Web service.

31. The apparatus of claim 17, wherein said seller comprises a merchant of said good and/or service.

32. The apparatus of claim 31, wherein said computing platform is further adapted to adjust a credit and/or debit account associated with said customer in response to completion of said transaction.

33. A apparatus comprising:
means for receiving information from a customer, said information being associated with said customer and an order for a transaction for a purchase of a good and/or service from a seller;
means for receiving metadata associated with said seller from a service other than said customer; and
means for selectively transmitting a payment notification to said seller for completion of said transaction based, at least in part, on metadata associated with said seller.

34. The apparatus of claim 33, and further comprising means for inhibiting said transmission of said payment notification based, at least in part, on a risk profile associated with said customer.

35. The apparatus of claim 34, and further comprising:
means for determining a first score based, at least in part, on said metadata; and
means for determining a second score based, at least in part, on said risk profile,
wherein said means for selectively transmitting a payment notification to said seller further comprises means for selectively transmitting said payment notification based, at least in part, on a comparison of said first and second scores.

36. The apparatus of claim 33, and further comprising means for selectively terminating said transaction based, at least in part, on said metadata.

37. The apparatus of claim 36, wherein said means for selectively terminating said transaction further comprises means for transmitting a termination message to said customer.

38. The apparatus of claim 37, wherein said means for selectively terminating said transaction further comprises means for transmitting a termination message to said seller.

39. The apparatus of claim 33, wherein said metadata associated with said seller comprises information descriptive of goods and/or services available by said seller.

40. The apparatus of claim 33, wherein said metadata associated with said seller comprises information descriptive of a location of said seller.

41. The apparatus of claim 33, wherein said metadata further comprises an indication as to whether said seller is associated with a party on a criminal watch list.

42. The apparatus of claim 33, wherein said metadata further comprises information indicative of a degree of commoditization of at least one good and/or service offered by said seller.

43. The apparatus of claim 33, and further comprising means for determining whether to complete said transaction based, at least in part, on a comparison of said metadata and a risk profile associated with said consumer.

44. The apparatus of claim 33, and further comprising means for receiving said metadata from a trusted source.

45. The apparatus of claim 33, wherein at least a portion of said metadata is derived from a government database.

46. The apparatus of claim 33, wherein said service comprises a Web service.

47. The apparatus of claim 33, wherein said seller comprises a merchant of said good and/or service.

48. The apparatus of claim 47, and further comprising means for adjusting a credit and/or debit account associated with said customer in response to completion of said transaction.

49. An article comprising:
a storage medium comprising machine-readable instructions thereon which, when executed, enable a computing platform to perform the following:
receive information from a customer, said information being associated with said customer and an order for a transaction for a purchase of a good and/or service from a seller;
receive metadata associated with said seller from a service other than said customer; and
selectively transmit a payment notification to said seller for completion of said transaction based, at least in part, on metadata associated with said seller.
